(19) United States
(12) Patent Application Publication
(10) Pub. No.: US 2023/0250691 A1
(43) Pub. Date: Aug. 10, 2023

(54) Porch Screen Assembly

(71) Applicant: Jonathan Riddle, Grayslake, IL (US)

(72) Inventor: Jonathan Riddle, Grayslake, IL (US)

(21) Appl. No.: 17/668,842

(22) Filed: Feb. 10, 2022

(51) Int. Cl. E06B 9/52

(52) U.S. Cl. CPC E06B 9/521; E06B 9/522; A47H 1/06

(57) ABSTRACT

A porch screen assembly for inhibiting insects from entering a porch includes a track that is mountable to an exterior of a porch has the track extending over an opening in the porch. A plurality of rollers each rollably engages the track and a plurality of hangers is each engaged to a respective one of the rollers. A plurality of curtains is each suspended from respective ones of the plurality of hangers thereby facilitating each of the curtains to be aligned with the opening in the porch. A plurality of weights is each coupled to a respective one of the curtains to inhibit the curtains from being blown about by the wind.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING 20 SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to screen devices and more particularly pertains to a new screen device for inhibiting insects from entering a porch. The device includes a track that is mounted to a porch and a plurality of rollers that are disposed in the track. A plurality of hangers is each engaged to a respective one of the rollers and a plurality of curtains is each suspended from respective hangers. Each of the curtains is comprised of a mesh material and each of the curtains is positionable to cover an opening in the porch thereby inhibiting insects from entering the porch. Furthermore, the curtains are releasably matable to each other and to structural elements of the porch.

### (2) Description of Related Art Including Information Disclosed Under 37 CFR 1.97 and 1.98.

The prior art relates to screen devices including a magnetic screen device that includes magnetic strips which engage edges of a garage door opening. The prior art discloses a porch screening device that includes stanchions, cross members and curtains suspended from the cross members for enclosing a porch with the curtains. The prior art discloses a variety of porch screen devices that each includes a plurality of screens which are permanently fastened to a porch for enclosing the porch. The prior art discloses an automobile screen device that includes a screen and a plurality of magnets integrated into the screen for magnetically engaging body panels of a vehicle. The prior art discloses a deployable porch screen device that includes tubular rollers and screens that are rolled around the tubular rollers and which are extendable downwardly on a porch for enclosing the porch.

### BRIEF SUMMARY OF THE INVENTION

An embodiment of the disclosure meets the needs presented above by generally comprising a track that is mountable to an exterior of a porch has the track extending over an opening in the porch. A plurality of rollers each rollably engages the track and a plurality of hangers is each engaged to a respective one of the rollers. A plurality of curtains is each suspended from respective ones of the plurality of hangers thereby facilitating each of the curtains to be aligned with the opening in the porch. A plurality of weights is each coupled to a respective one of the curtains to inhibit the curtains from being blown about by the wind.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of a porch screen assembly according to an embodiment of the disclosure.

FIG. 2 is a front view of an embodiment of the disclosure.

FIG. 3 is a back view of an embodiment of the disclosure.

FIG. 4 is a perspective view of a track, a roller and a hanger of an embodiment of the disclosure.

### DETAILED DESCRIPTION OF THE INVENTION

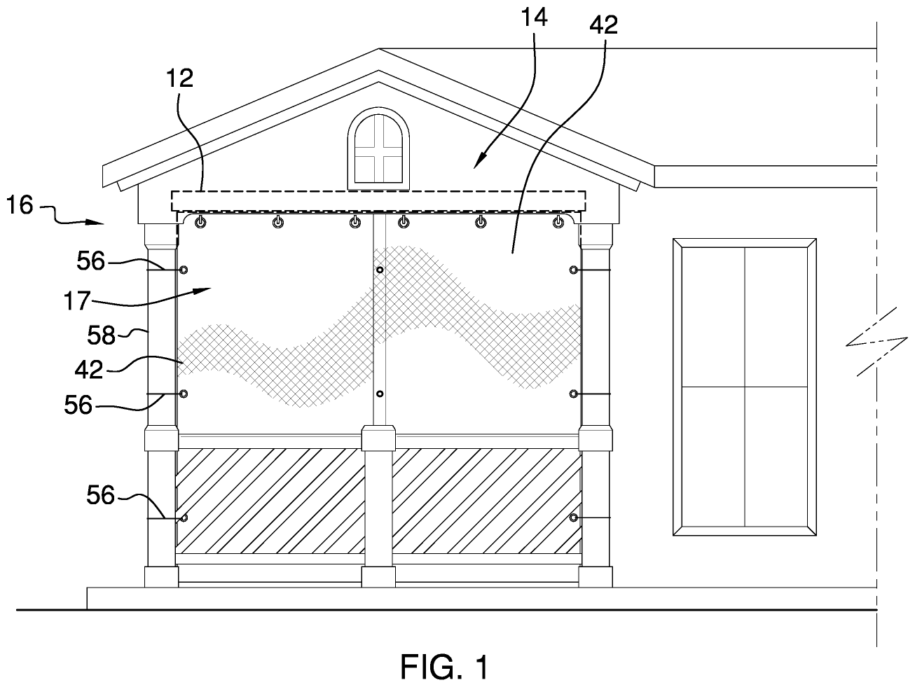

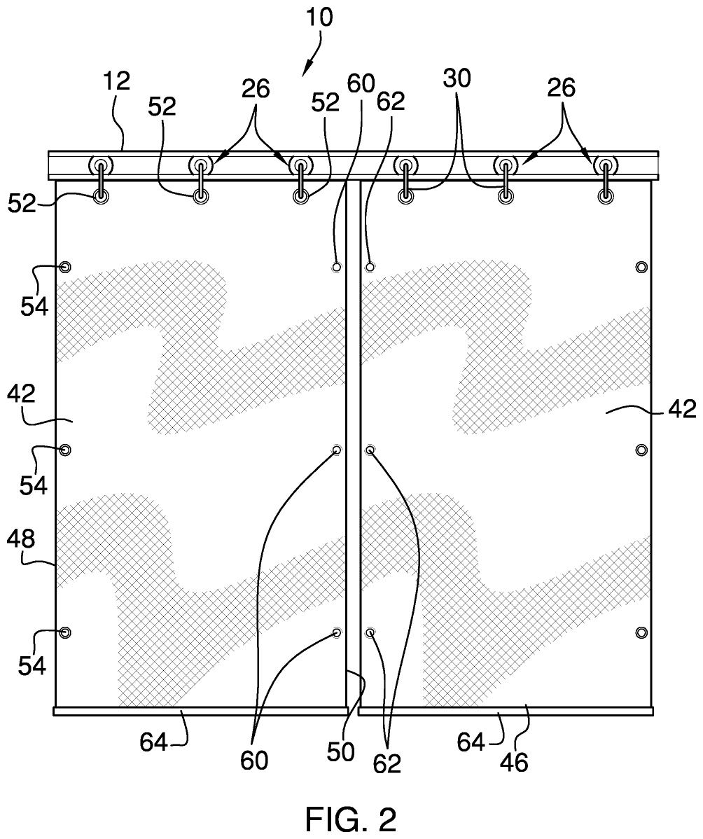

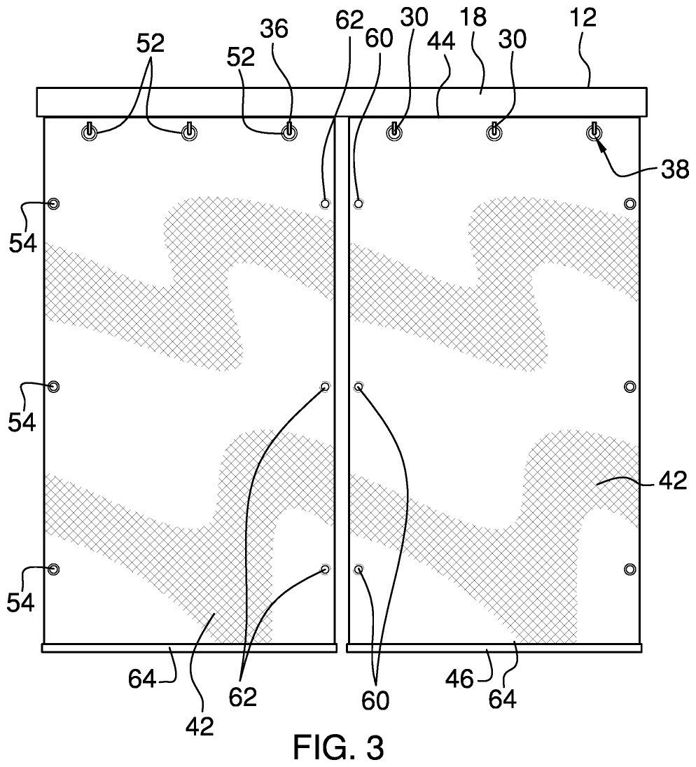

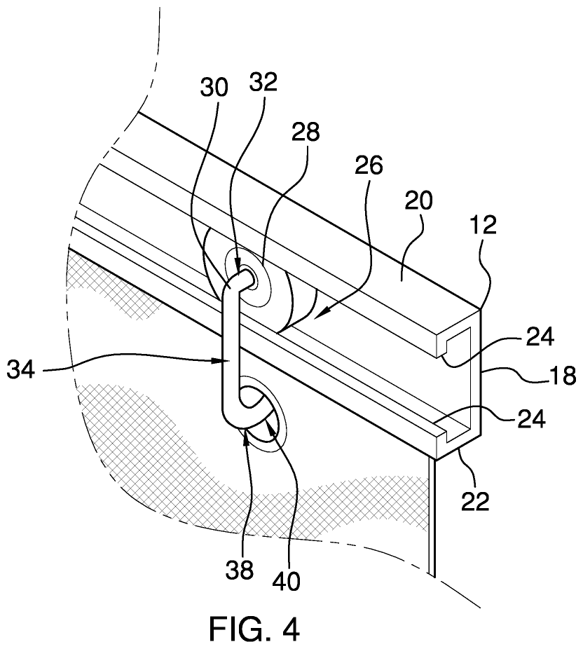

With reference now to the drawings, and in particular to FIGS. 1 through 4 thereof, a new screen device embodying the principles and concepts of an embodiment of the disclosure and generally designated by the reference numeral 10 will be described.

As best illustrated in FIGS. 1 through 4, the porch screen assembly 10 generally comprises a track 12 is mountable to an exterior 14 of a porch 16 having the track 12 extending over an opening 17 in the porch 16. The track 12 has rear wall 18, a top wall 20 and a bottom wall 22, and each of the top wall 20 and the bottom wall 22 has a tab 24 that is distally positioned from the rear wall 18. The tab 24 on the top wall 20 is directed toward the tab 24 on the bottom wall 22, and the tab 24 on each of the top wall 20 and the bottom wall 22 extends along a full length of the top wall 20 and the bottom wall 22. The rear wall 18 is mounted to the exterior 14 of the porch 16 having each of the top wall 20 and the bottom wall 22 extending away from the exterior 14 of the porch 16. The porch 16 may be an open porch on a house or other type of structure and the porch 16 has a roof, no doors and no windows.

A plurality of rollers 26 is provided and each of the rollers 26 rollably engages the track 12. Each of the rollers 26 engages the top wall 20 and the bottom wall 22 of the track 12, and the tab 24 on each of the top wall 20 and the bottom wall 22 inhibits the rollers 26 from exiting the track 12. Each of the rollers 26 is rollable along a full length of the track 12, and each of the rollers 26 includes a bearing 28 is centrally positioned in the rollers 26. Each of the rollers 26 may comprise a rubber wheel or the like and the bearing 28 may comprise a ring bearing or other type of friction reducing bearing.

A plurality of hangers 30 is provided and each of the hangers 30 is engaged to a respective one of the rollers 26. Each of the hangers 30 has a first portion 32 engaging the bearing 28 in the respective roller and a second portion 34 extending downwardly from the first portion 32. The second portion 34 has a distal end 36 with respect to the first portion 32. Furthermore, the second portion 34 has a curve 38 that is positioned adjacent to the distal end 36 to define a hook 40 having the distal end 36 directed upwardly toward the first portion 32.

A plurality of curtains 42 is each suspended from respective ones of the plurality of hangers 30 thereby facilitating each of the curtains 42 to be aligned with the opening 17 in the porch 16. Each of the curtains 42 is comprised of a mesh material to inhibit insects from passing through the curtains 42. Each of the curtains 42 has a top edge 44, a bottom edge 46, a first lateral edge 48 and a second lateral edge 50. Each of the curtains 42 has a plurality of first grommets 52 integrated into the curtains 42, and the first grommets 52 are spaced apart from each other and are distributed along the top edge 44 of a respective curtain 42. Each of the first grommets 52 insertably receives the distal end 36 of the second portion 34 of a respective one of the hangers 30 for suspending the curtains 42 on the hook 40 defined on each of the hangers 30.

Each of the curtains 42 has a plurality of second grommets 54 each integrated into the curtains 42. The second grommets 54 are spaced apart from each other and are distributed along the first lateral edge 48 of a respective one of the curtains 42 and the second lateral edge 50 of a respective one of the curtains 42. Each of the second grommets 54 receives a respective fastener 56 attached to a respective post 58 of the porch 16 for securing each of the curtains 42 to the respective post 58. The fastener 56 may comprise a nail, a threaded hook or any type of fastener that can engage the second grommets 54.

A plurality of first magnets 60 is each integrated into a respective one of the curtains 42. The first magnets 60 are spaced apart from each other and are distributed along the second lateral edge 50 of the respective curtain 42. A plurality of second magnets 62 is each integrated into a respective one of the curtains 42. The second magnets 62 are spaced apart from each other and are distributed along the first lateral edge 48 of the respective curtain 42. Each of the second magnets 62 engages a respective one of the first magnets 60 for securing the plurality of curtains 42 to each other. In this way the first magnets 60 and the second magnets 62 inhibit insects from passing between the plurality of curtains 42.

A plurality of weights 64 is provided and each of the weights 64 is coupled to a respective one of the curtains 42 to inhibit the curtains 42 from being blown about by the wind. Each of the weights 64 is positioned on the bottom edge 46 of the respective curtain. Additionally, each of the weights 64 is elongated to extend along a full length of the bottom edge 46. Each of the weights 64 may have a weight ranging between approximately 0.5 pounds and 1.0 pound.

In use, the track 12 is mounted at a desired location over the opening 17 in the porch 16. In this way the curtains 42 can be positioned to cover the opening 17 in the porch 16. Each of the second grommets 54 is attached to the respective post 58 and each of the first magnets 60 is manipulated to engage a respective one of the second magnets 62. In this way the curtains 42 inhibit insects from passing through the opening 17 in the porch 16. Thus, occupants of the porch 16 can enjoy the porch 16 without being bitten by mosquitos, for example, or other insects. A plurality of the tracks 12 can each be positioned over respective openings 18 in the porch 16 for completely enclosing the porch 16 with the curtains 42. Additionally, the curtains 42 can be removed from the hangers 30 at any time for storing the curtains 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A porch screen assembly for temporarily enclosing a porch in a screen to inhibit insects from entering the porch, said assembly comprising:
a track being mountable to an exterior of a porch having said track extending over an opening in the porch;
a plurality of rollers, each of said rollers rollably engaging said track;
a plurality of hangers, each of said hangers being engaged to a respective one of said rollers;
a plurality of curtains, each of said curtains being suspended from respective ones of said plurality of hangers thereby facilitating each of said curtains to be aligned with the opening in the porch, each of said curtains being comprised of a mesh material wherein each of said curtains is configured to inhibit insects from passing through said curtains; and
a plurality of weights, each of said weights being coupled to a respective one of said curtains wherein each of said weights is configured to inhibit said curtains from being blown about by the wind.

2. The assembly according to claim 1, wherein said track has rear wall, a top wall and a bottom wall, each of said top wall and said bottom wall having a tab being distally positioned from said rear wall, said tab on said top wall being directed toward said tab on said bottom wall, said tab on each of said top wall and said bottom wall extending along a full length of said top wall and said bottom wall, said rear wall being mounted to the exterior of the porch having each of said top wall and said bottom wall extending away from the exterior of the porch.

3. The assembly according to claim 2, wherein each of said rollers engages said top wall and said bottom wall of said track, said tab on each of said top wall and said bottom wall inhibiting said rollers from exiting said track, each of said rollers being rollable along a full length of said track.

4. The assembly according to claim 1, wherein each of said rollers includes a bearing being centrally positioned in said rollers.

5. The assembly according to claim 4, wherein each of said hangers has a first portion engaging said bearing in said respective roller and a second portion extending downwardly from said first portion, said second portion having a distal end with respect to said first portion, said second portion having a curve being positioned adjacent to said distal end to define a hook having said distal end being directed upwardly toward said first portion.

6. The assembly according to claim 5, wherein each of said curtains has a top edge, a bottom edge, a first lateral edge and a second lateral edge, each of said curtains having a plurality of first grommets each being integrated into said curtains, said first grommets being spaced apart from each other and being distributed along said top edge of a respective curtain, each of said first grommets insertably receiving said distal end of said second portion of a respective one of said hangers for suspending said curtains on said hook defined on each of said hangers.

7. The assembly according to claim 6, wherein each of said curtains has a plurality of second grommets each being integrated into said curtains, said second grommets being spaced apart from each other and being distributed along said first lateral edge of a respective one of said curtains and said second lateral edge of a respective one of said curtains, each of said second grommets receiving a respective fastener attached to a respective post of the porch for securing each of said curtains to the respective post.

8. The assembly according to claim 6, further comprising a plurality of first magnets, each of said first magnets being integrated into a respective one of said curtains, said first magnets being spaced apart from each other and being distributed along said second lateral edge of said respective curtain.

9. The assembly according to claim 8, further comprising a plurality of second magnets, each of said second magnets being integrated into a respective one of said curtains, said second magnets being spaced apart from each other and being distributed along said first lateral edge of said respective curtain, each of said second magnets engaging a respective one of said first magnets for securing said plurality of curtains to each other wherein said first magnets and said second magnets are configured to inhibit insects from passing between said plurality of curtains.

10. A porch screen assembly for temporarily enclosing a porch in a screen to inhibit insects from entering the porch, said assembly comprising:
a track being mountable to an exterior of a porch having said track extending over an opening in the porch, said track having rear wall, a top wall and a bottom wall, each of said top wall and said bottom wall having a tab being distally positioned from said rear wall, said tab on said top wall being directed toward said tab on said bottom wall, said tab on each of said top wall and said bottom wall extending along a full length of said top wall and said bottom wall, said rear wall being mounted to the exterior of the porch having each of said top wall and said bottom wall extending away from the exterior of the porch;
a plurality of rollers, each of said rollers rollably engaging said track, each of said rollers engaging said top wall and said bottom wall of said track, said tab on each of said top wall and said bottom wall inhibiting said rollers from exiting said track, each of said rollers being rollable along a full length of said track, each of said rollers including a bearing being centrally positioned in said rollers;
a plurality of hangers, each of said hangers being engaged to a respective one of said rollers, each of said hangers having a first portion engaging said bearing in said respective roller and a second portion extending downwardly from said first portion, said second portion having a distal end with respect to said first portion, said second portion having a curve being positioned adjacent to said distal end to define a hook having said distal end being directed upwardly toward said first portion;
a plurality of curtains, each of said curtains being suspended from respective ones of said plurality of hangers thereby facilitating each of said curtains to be aligned with the opening in the porch, each of said curtains being comprised of a mesh material wherein each of said curtains is configured to inhibit insects from passing through said curtains, each of said curtains having a top edge, a bottom edge, a first lateral edge and a second lateral edge, each of said curtains having a plurality of first grommets each being integrated into said curtains, said first grommets being spaced apart from each other and being distributed along said top edge of a respective curtain, each of said first grommets insertably receiving said distal end of said second portion of a respective one of said hangers for suspending said curtains on said hook defined on each of said hangers, each of said curtains having a plurality of second grommets each being integrated into said curtains, said second grommets being spaced apart from each other and being distributed along said first lateral edge of a respective one of said curtains and said second lateral edge of a respective one of said curtains, each of said second grommets receiving a respective fastener attached to a respective post of the porch for securing each of said curtains to the respective post;
a plurality of first magnets, each of said first magnets being integrated into a respective one of said curtains, said first magnets being spaced apart from each other and being distributed along said second lateral edge of said respective curtain;
a plurality of second magnets, each of said second magnets being integrated into a respective one of said curtains, said second magnets being spaced apart from each other and being distributed along said first lateral edge of said respective curtain, each of said second magnets engaging a respective one of said first magnets for securing said plurality of curtains to each other wherein said first magnets and said second magnets are configured to inhibit insects from passing between said plurality of curtains; and
a plurality of weights, each of said weights being coupled to a respective one of said curtains wherein each of said weights is configured to inhibit said curtains from being blown about by the wind, each of said weights being positioned on said bottom edge of said respective curtain, each of said weights being elongated to extend along a full length of said bottom edge.

11. A porch screen system for temporarily enclosing a porch in a screen to inhibit insects from entering said porch, said system comprising:
a building having a porch, said porch having an opening;
a track being mountable to an exterior of said porch having said track extending over said opening in said porch, said track having rear wall, a top wall and a bottom wall, each of said top wall and said bottom wall having a tab being distally positioned from said rear wall, said tab on said top wall being directed toward said tab on said bottom wall, said tab on each of said top wall and said bottom wall extending along a full length of said top wall and said bottom wall, said rear wall being mounted to said exterior of said porch having each of said top wall and said bottom wall extending away from said exterior of said porch;
a plurality of rollers, each of said rollers rollably engaging said track, each of said rollers engaging said top wall and said bottom wall of said track, said tab on each of said top wall and said bottom wall inhibiting said rollers from exiting said track, each of said rollers being rollable along a full length of said track, each of said rollers including a bearing being centrally positioned in said rollers;
a plurality of hangers, each of said hangers being engaged to a respective one of said rollers, each of said hangers having a first portion engaging said bearing in said respective roller and a second portion extending downwardly from said first portion, said second portion having a distal end with respect to said first portion, said second portion having a curve being positioned adjacent to said distal end to define a hook having said distal end being directed upwardly toward said first portion;
a plurality of curtains, each of said curtains being suspended from respective ones of said plurality of hangers thereby facilitating each of said curtains to be aligned with said opening in said porch, each of said curtains being comprised of a mesh material wherein each of said curtains is configured to inhibit insects from passing through said curtains, each of said curtains having a top edge, a bottom edge, a first lateral edge and a second lateral edge, each of said curtains having a plurality of first grommets each being integrated into said curtains, said first grommets being spaced apart from each other and being distributed along said top edge of a respective curtain, each of said first grommets insertably receiving said distal end of said second portion of a respective one of said hangers for suspending said curtains on said hook defined on each of said hangers, each of said curtains having a plurality of second grommets each being integrated into said curtains, said second grommets being spaced apart from each other and being distributed along said first lateral edge of a respective one of said curtains and said second lateral edge of a respective one of said curtains, each of said second grommets receiving a respective fastener attached to a respective post of said porch for securing each of said curtains to said respective post;
a plurality of first magnets, each of said first magnets being integrated into a respective one of said curtains, said first magnets being spaced apart from each other and being distributed along said second lateral edge of said respective curtain;
a plurality of second magnets, each of said second magnets being integrated into a respective one of said curtains, said second magnets being spaced apart from each other and being distributed along said first lateral edge of said respective curtain, each of said second magnets engaging a respective one of said first magnets for securing said plurality of curtains to each other wherein said first magnets and said second magnets are configured to inhibit insects from passing between said plurality of curtains; and
a plurality of weights, each of said weights being coupled to a respective one of said curtains wherein each of said weights is configured to inhibit said curtains from being blown about by the wind, each of said weights being positioned on said bottom edge of said respective curtain, each of said weights being elongated to extend along a full length of said bottom edge.
